(19) United States
(12) Patent Application Publication
(10) Pub. No.: US 2011/0030923 A1
(43) Pub. Date: Feb. 10, 2011

(54) THERMAL MODULE

(75) Inventors: CHENG-JEN LIANG, Tu-Cheng (TW); JUI-WEN HUNG, Tu-Cheng (TW); NIEN-TIEN CHENG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/581,173

(22) Filed: Oct. 19, 2009

(30) Foreign Application Priority Data
Aug. 4, 2009 (CN) 200910305180.3

(51) Int. Cl. F28D 15/02; F28D 21/00; G06F 1/20

(52) U.S. Cl. 165/104.26; 165/121

(57) ABSTRACT

A thermal module comprises a cooling fan, a heat pipe and a fin assembly. The cooling fan defines an air outlet therein. The fin assembly is mounted at the air outlet of the cooling fan. The heat pipe comprises an evaporating section attached to the cooling fan and a condensing section attached to the fin assembly. The evaporating section of the heat pipe is wholly located within an inner space of the cooling fan.

### BACKGROUND

1. Technical Field

The present disclosure relates to thermal modules, and particularly to a compact thermal module for use in a portable electronic device.

2. Description of Related Art

With continuing development of electronic technology, heat-generating electronic components of electronic devices such as CPUs (central processing units) are generating more and more heat which requires immediate dissipation, especially in portable electronic devices such as portable computers which do not have enough space therein. Generally, thermal modules are attached to the electronic components to provide such heat dissipation.

A conventional thermal module disclosed by Chinese patent application publication No. CN101365320A includes a substrate for absorbing heat from an electronic component, a cooling fan located far away from the electronic component and the substrate, a fin assembly mounted at the cooling fan and a heat pipe connecting the substrate and the fin assembly. The heat pipe is elongated, including two opposite ends. One end of the heat pipe is connected with the substrate and the other end of the heat pipe is connected with the fin assembly to transfer heat from the substrate to the fin assembly. The cooling fan provides a forced airflow to the fin assembly to accelerate the heat dissipation of the fin assembly. However, the thermal module has a large size, whereby the thermal module should occupy a large mounting space which deviates from a trend toward miniaturization in computer industry. Furthermore, although the heat of the electronic component is largely transferred to the fin assembly and taken away by the forced airflow of the cooling fan, there is still a portion of the heat of the electronic component is radiated by the substrate and the heat pipe into an interior of a portable computer in which the thermal module is mounted, and that portion of heat radiated into the interior of the portable computer will cause damage to a variety of electronic components mounted in the portable computer.

Therefore, a compact thermal module with a compact structure and an efficient heat dissipation performance is desired to overcome the above described shortcomings.

### BRIEF DESCRIPTION OF THE DRAWINGS

FIG. 1 is an exploded, isometric view of a thermal module in accordance with an exemplary embodiment.

FIG. 2 is similar to FIG. 1, but viewed from another aspect.

FIG. 3 is a partially assembled, isometric view of the thermal module of FIG. 1.

FIG. 4 is an assembled, isometric view of the thermal module of FIG. 1.

### DETAILED DESCRIPTION

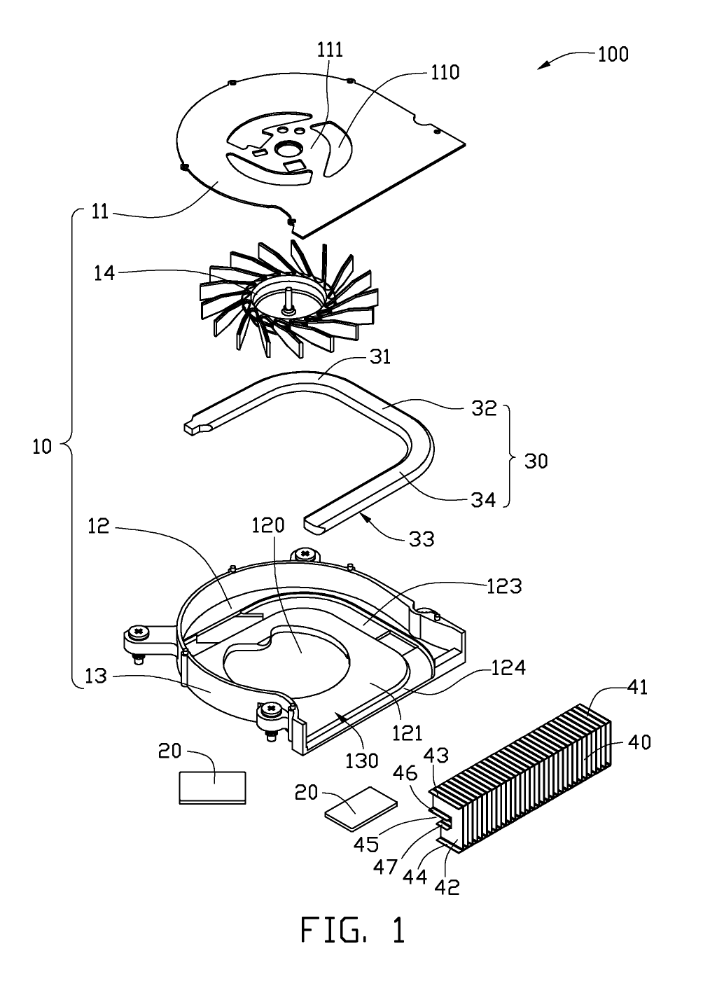

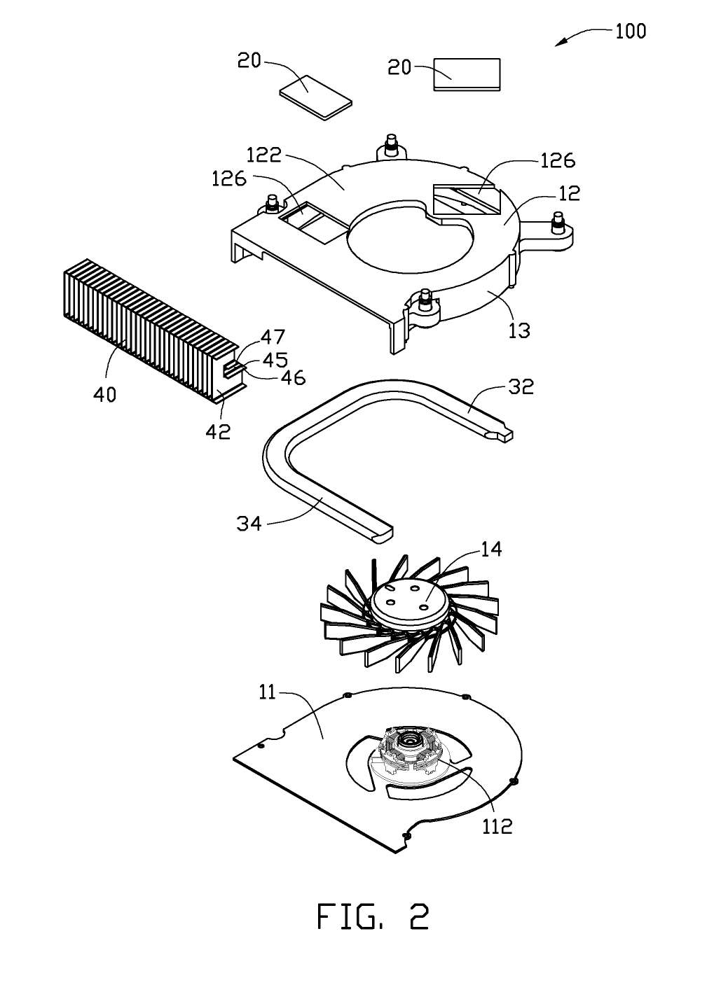

Referring to FIGS. 1 and 2, a thermal module 100 in accordance with an exemplary embodiment of the present disclosure is shown. The thermal module 100 includes a cooling fan 10, a fin assembly 40 located beside the cooling fan 10, two heat absorbing plates 20 attached to a bottom side of the cooling fan 10, and a heat pipe 30 received in the cooling fan 10 and connected with the heat absorbing plates 20 and the fin assembly 40.

The heat absorbing plates 20 are used for contacting with heat-generating electronic components such as a CPU and a GPU of a portable computer. The heat absorbing plates 20 are made of metal with a high heat conductivity coefficient, such as copper. The heat absorbing plates 20 each are rectangular.

The heat pipe 30 is U-shaped, including, along an extending direction of the heat pipe 30, an L-shaped evaporating section 32 and a linear condensing section 34. An interior of the heat pipe 30 is hollow and vacuumed, and a working fluid is filled in the heat pipe 30. The heat pipe 30 is flat, thus forming a planar top surface 31 and a planar bottom surface 33 opposite to the top surface 31.

The cooling fan 10 includes an impeller 14, a top plate 11, a bottom plate 12 parallel to the top plate 11 and a sidewall 13 interconnecting the top plate 11 with the bottom plate 12. The top plate 11, the bottom plate 12 and the sidewall 13 cooperatively define a receiving space for receiving the impeller 14 therein. The cooling fan 10 defines a first air inlet 110 at the top plate 11, a second air inlet 120 at the bottom plate 12 and an air outlet 130 at the sidewall 13, wherein the air outlet 130 is perpendicular to the first and second air inlets 110, 120.

The top plate 11 of the cooling fan 10 forms a mounting base 111 at a central portion of the first air inlet 110. The impeller 14 is invertedly mounted to the mounting base 111. The impeller 14 is located above the bottom plate 12 and aligned with the second air inlet 120 of the bottom plate 12. The bottom plate 12 is made of metal. The sidewall 13 is integrally formed with the bottom plate 12.

The bottom plate 12 of the cooling fan 10 includes an upper surface 121 facing the top plate 11 and a lower surface 122 opposite to the upper surface 121. The bottom plate 12 of the cooling fan 10 defines an elongated groove 123 in the upper surface 121 for receiving the evaporating section 32 of the heat pipe 30. The groove 123 is disposed around the second air inlet 120 and extends from an interior of the cooling fan 10 to the air outlet 130. The groove 123 has a depth smaller than a thickness of the bottom plate 12. The bottom plate 12 defines two recesses 126 at the lower surface 122 of the bottom plate 12 for receiving the heat absorbing plates 20, respectively. The recesses 126 communicate with the groove 123, such that the evaporating section 32 of the heat pipe 30 received in the groove 123 can contact with the heat absorbing plates 20 received in the recesses 126 directly.

The bottom plate 12 of the cooling fan 10 further defines a recessed step 124 in the upper surface 121 near the air outlet 130. The recessed step 124 extends from one side of the air outlet 130 to the other side of the air outlet 130. The recessed step 124 is connected with the groove 123 at the air outlet 130. The recessed step 124 is used for mounting the condensing section 34 of the heat pipe 30. A width of the recessed step 124 is smaller than that of the condensing section 34 of the heat pipe 30, such that when the condensing section 34 of the heat pipe 30 is attached to the recessed step 124 of the bottom plate 12 of the cooling fan 10, only an inner portion of the condensing section 34 of the heat pipe 30 abuts on the recessed step 124 while an outer portion of the condensing section 34 of the heat pipe 30 protrudes out of the recessed step 124.

The fin assembly 40 includes a plurality of fins 41 stacked together along the air outlet 130 of the cooling fan 10. The fins 41 have the same shape and structure as each other. Each of the fins 41 includes a main body 42 and two flanges 43, 44 extending forwards from top and bottom sides of the main body 42 towards a front one of the fins 41. Each fin 41 defines a U-shaped notch at a middle of the main body 42 facing the air outlet 130 of the cooling fan 10. An upper portion of the main body 42 of each fin 41 above the notch has a width larger than that of a lower portion of the main body 42 below the notch. A top hem 46 and a bottom hem 47 respectively extend from top and bottom sides of the notch of each of the fins 41. The top hem 46 is longer than the bottom hem 47. All of the notches of the fins 41 align with each other to form an elongated slot 45 at the middle of the fin assembly 40. All of the top hems 46 of the fins 41 are coplanar to form an upper contacting surface at the top side of the slot 45, and all of the bottom hems 47 of the fins 41 are coplanar to form a lower contacting surface at the bottom side of the slot 45.

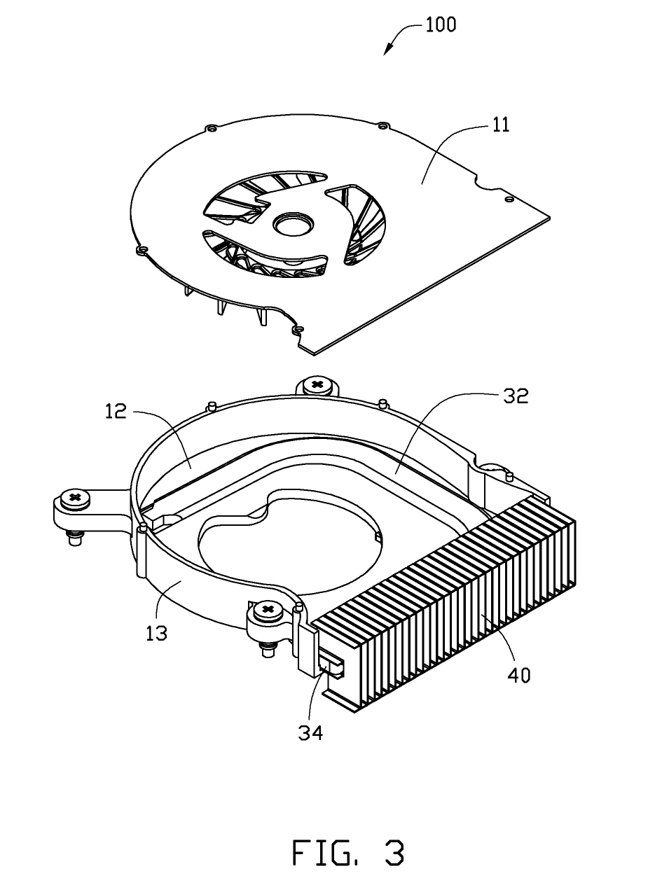

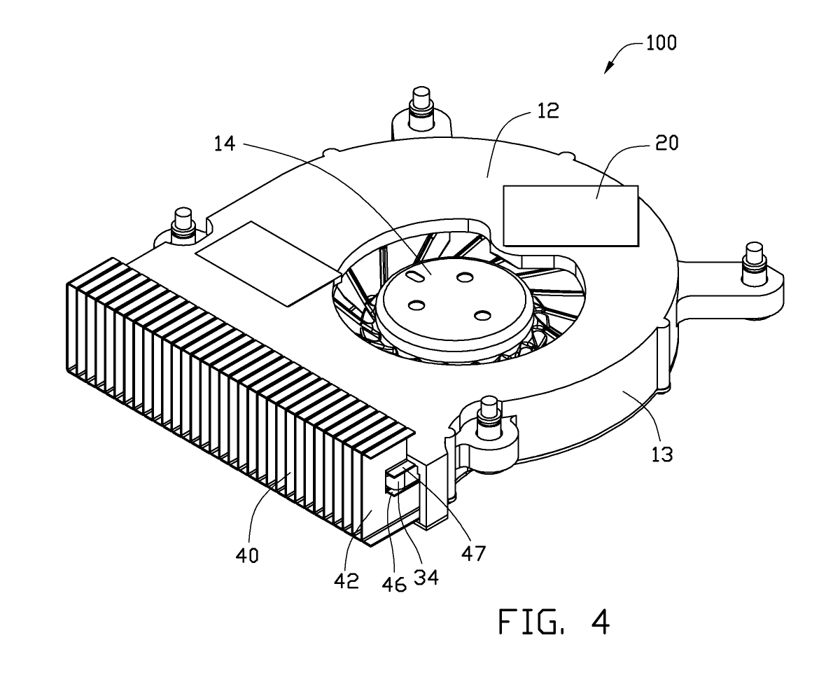

Referring to FIGS. 3 and 4, in assembly, the heat pipe 30 is attached to the bottom plate 12 of the cooling fan 10 with the evaporating section 32 being received in the groove 123 and the condensing section 34 being attached to the recessed step 124. The heat absorbing plates 20 are received in the recesses 126, respectively. The heat absorbing plates 20 are directly contacted with the bottom surface 33 of the evaporating section 32 of the heat pipe 30. The top surface 31 of the heat pipe 30 is spaced from the impeller 14 to avoid an interference with the rotating impeller 14.

The fin assembly 40 is attached to the air outlet 130 of the cooling fan 10 with the slot 45 facing the recessed step 124 of the cooling fan 10. The inner portion of the condensing section 34 of the heat pipe 30 is located on the recessed step 124 and the outer portion of the condensing section 34 of the heat pipe 30 is received in the slot 45 of the fin assembly 40. The lower portion of the fin assembly 40 below the slot 45 abuts against an outer side of the recessed step 124, and the upper portion of the fin assembly 40 above the slot 45 extends inwardly into the air outlet 130 of the cooling fan 10. The top hems 46 of the fins 41 of the fin assembly 40 contact with the whole top surface 31 of the condensing section 34 of the heat pipe 30, while the bottom hems 47 of the fins 41 of the fin assembly 40 are attached to the bottom surface 33 of the outer portion of the condensing section 34 of the heat pipe 30.

Since the heat pipe 30 and the heat absorbing plates 20 are received in the cooling fan 10, the size of the thermal module 100 is reduced greatly, and thus the thermal module 100 is more compact than a conventional one. In addition, in mounting the thermal module 100 to a PCB (printed circuit board) of a portable computer on which the heat-generating electronic components are mounted, it only needs to mount the cooling fan 10 to the PCB since the heat absorbing plates 20, the heat pipe 30 and the fin assembly 40 have been pre-assembled together with the cooling fan 10 beforehand.

During operation, the heat absorbing plates 20 absorb heat from the electronic components and transfer the heat to the evaporating section 32 of the heat pipe 30, and then to the condensing section 34 of the heat pipe 30. The condensing section 34 transfers the heat to the fin assembly 40. As the heat absorbing plate 20 and the heat pipe 30 are wholly located within an area covered by the cooling fan 10, the heat of the electronic components can be timely and effectively taken away by the cooling fan 10 without being radiated into an interior of the portable computer in which the electronic components are mounted. Thus, a heat dissipation efficiency of the thermal module 100 is increased accordingly.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A thermal module, comprising:
a cooling fan defining an air outlet therein;
a fin assembly mounted at the air outlet of the cooling fan; and
a heat pipe comprising an evaporating section attached to the cooling fan and a condensing section attached to the fin assembly, the evaporating section being wholly located within an internal space of the cooling fan.

2. The thermal module of claim 1, wherein the cooling fan comprises a top plate, a bottom plate opposite to the top plate and an impeller located between the top plate and the bottom plate, the bottom plate defining a groove for receiving the evaporating section of the heat pipe therein.

3. The thermal module of claim 2, wherein the bottom plate of the cooling fan forms an upper surface and a lower surface, and the groove is defined in the upper surface of the bottom plate of the cooling fan.

4. The thermal module of claim 3, wherein a depth of the groove of the bottom plate is smaller than a thickness of the bottom plate of the cooling fan.

5. The thermal module of claim 3, further comprising a heat absorbing plate attached to a lower surface of the bottom plate of the cooling fan and engaging and thermally connecting with the evaporating section of the heat pipe.

6. The thermal module of claim 5, wherein the bottom plate of the cooling fan defines a recess at the lower surface of the bottom plate for receiving the heat absorbing plate therein.

7. The thermal module of claim 2, wherein the impeller of the cooling fan is invertedly mounted to the top plate and spaced from the bottom plate of the cooling fan.

8. The thermal module of claim 2, wherein the bottom plate defines an air inlet at a central portion thereof, and the groove is disposed around the air inlet.

9. The thermal module of claim 2, wherein the evaporating section of the heat pipe is L-shaped and the groove is L-shaped corresponding to the evaporating section of the heat pipe.

10. The thermal module of claim 2, wherein the bottom plate of the cooling fan further defines a recessed step near the air outlet for mounting the condensing section of the heat pipe thereon.

11. The thermal module of claim 10, wherein a width of the recessed step is smaller than that of the condensing section of the heat pipe, an inner portion of the condensing section of the heat pipe abutting on the recessed step while an outer portion of the condensing section of the heat pipe protruding out of the recessed step.

12. The thermal module of claim 11, wherein the fin assembly comprises a plurality of fins stacked together along the air outlet of the cooling fan, the fin assembly defining a U-shaped slot at a middle thereof, the slot facing the recessed step of the cooling fan, the outer portion of the condensing section of the heat pipe being received in the slot of the fin assembly.

13. The thermal module of claim 12, wherein each of the fins forms a top hem and a bottom hem respectively from top and bottom sides of the slot, the top and bottom hems contacting with top and bottom surfaces of the condensing section of the heat pipe, respectively.

14. The thermal module of claim 13, wherein the top hem is longer than the bottom hem.

15. A thermal module comprising:
a fan comprising:
a housing having a top plate, a bottom plate below the top plate and an air outlet at a side of the housing between the top and bottom plates; and
an impeller rotatably mounted on the top plate and positioned between the top and bottom plates;
a heat pipe having an evaporating portion totally received in the housing of the fan and mounted in the bottom plate of the housing and a condensing portion extending to the outlet of the housing; and
a fin assembly attached to the condensing portion of the heat pipe.

16. The thermal module of claim 15, wherein the bottom plate defines a groove in a top face therefore for receiving the evaporating portion of the heat pipe therein, and a recess in a bottom face thereof, the recess communicating with the groove, a heat absorbing plate being received in the recess.

17. The thermal module of claim 16, wherein the bottom plate defines another recess in the bottom face thereof, the another recess communication with the groove, another heat absorbing plate being received in the another recess.

18. The thermal module of claim 17, wherein the fin assembly has an upper portion extending into the housing of the fan and a lower portion located outside the housing of the fan.
